(19) United States
(12) Patent Application Publication
(10) Pub. No.: US 2007/0118292 A1
(43) Pub. Date: May 24, 2007

(54) Stress and pore pressure limits using a strength of materials approach

(75) Inventor: Daniel Moos, Palo Alto, CA (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: GeoMechanics International, Inc., Houston, TX (US)

(21) Appl. No.: 11/601,950

(22) Filed: Nov. 20, 2006

Related U.S. Application Data
(60) Provisional application No. 60/738,909, filed on Nov. 22, 2005.

(51) Int. Cl. G01V 1/00; G06F 19/00

(52) U.S. Cl. 702/14

(57) ABSTRACT

A method of developing a reservoir in an earth formation. Seismic measurements are used for defining the first set of constraints in distress diagram characterizing the subsurface. Trend data are used for defining additional constraints in distress diagram. These constraints are used in performing operations for relating to the development of the reservoir.

### CROSS-REFERENCES TO RELATED APPLICATIONS

This application claims priority from U.S. Provisional patent application Ser. No. 60/738909 filed on 22 Nov. 2005.

### BACKGROUND OF THE INVENTION

This invention relates generally to evaluation of boreholes. More particularly, this invention relates tools for estimation of stresses in earth formations and the magnitude of pore pressure in the formations.

In order to optimize Oil & Gas operations, it is important to know the earth stresses and the magnitude of the pore pressure. Considerable effort has been devoted to developing methods to determine these parameters using either direct or indirect approaches. Examples of direct approaches include using fluid samplers to measure pore pressure, and using diagnostic miniature fracturing operations (minifracs) or extended leakoff tests to determine the least principal stress (usually, the minimum horizontal stress). Examples of indirect methods include using seismic velocity to estimate pore fluid pressure and fracture gradient, e.g., Eaton (1969); Bowers (U.S. Pat. No. 5200929).

It is almost impossible to measure all of the stresses and the pore pressure at the same depth. Therefore, indirect methods must be used to determine the values that cannot be measured. For example, the overburden pressure is typically determined by integrating the weight of material overlying the depth of interest.

A further class of indirect methods involves inverting observations of compressive and tensile failure of the rock at the wall of a wellbore to determine the magnitudes of the stresses (e.g., Moos and Zoback (1990); and Peska and Zoback (1995). Peska and Zoback utilized computations of the stresses required to cause tensile fractures to form on the wall of a hole with a given orientation, and also computed the stresses required to cause compressive failure to extend a given width around the well.

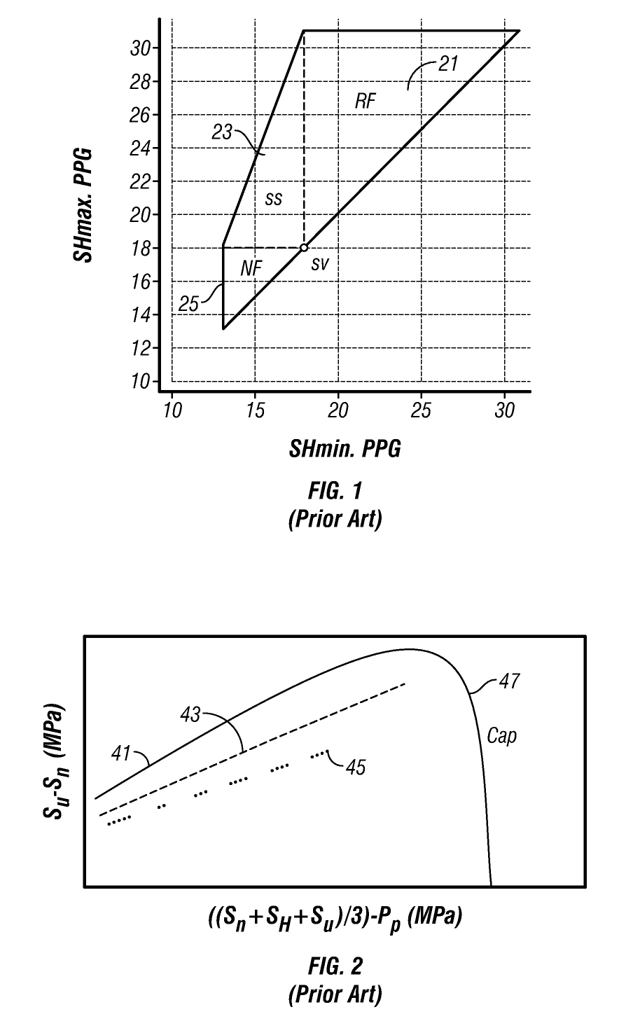

A further approach uses the properties of earth materials to derive constraints on the magnitudes of the stresses. One such approach is revealed by Zoback et al. (U.S. Pat. No. 4635719). The method is illustrated by example in FIG. 1, which shows limits on the minimum and maximum horizontal stresses (Sₕₘᵢₙ and S_{Hmax}) for a given value of vertical stress (Sᵥ) and pore pressure. The abscissa is the minimum principal stress and ordinate is the maximum principal stress.

The key to the method revealed by Zoback et al. is that stresses in the crust cannot take on arbitrary values but are limited by the strength of pre-existing fractures and faults. Because fractures, faults, and microcracks occur in the crust at all scales and all orientations, stresses cannot be such that any of these would fail in shear. Eqns. 1 and 2 define limits to the magnitudes of the stresses based on the frictional strength of pre-existing faults. Zoback et al. used the term “frictional equilibrium” to define a stress state in which the stresses and pore pressure are balanced by the strength of an optimally oriented fault, such that any increase in the shear stress along the fault or in the pore pressure would cause the stress to exceed its frictional strength, causing a slip event that relieves the excess stress. FIG. 1 is plotted for a specific depth, and assumes a specific pore pressure. Similar figures can be plotted using ratios of stress to the overburden or vertical stress S_{V}. The outer boundary of the polygon in FIG. 1 defines the limits of the horizontal stresses (here assumed to be principal stresses) that would generate slip on optimally oriented faults with the given coefficient of sliding friction (μ). It is assumed in this figure that the faults have no cohesion (S_{O}=0), but that assumption is not necessary to the method.
τ_{equilibrium}=S₀+σ_{equilibrium}×μ (1).
Rewritten in terms of the greatest and least principal stresses (S₁ and S₃ respectively) for the case when S₀=0, this becomes:

$$\frac{{S}_{1} - {P}_{p}}{{S}_{3} - {P}_{p}} = {( {( {μ}^{2} + 1 )}^{1 / 2} + μ )}^{2} . \qquad ( 2 )$$

The definitions of S₁, S₂ and S₃ in the earth depend on position on the diagram of FIG. 1. If Sᵥ=S₃, the stress state lies in the upper right region 21 and the crust is said to be in a reverse faulting stress state. If Sᵥ=S_{2,} the stress state lies in the upper left region 23 and the crust is said to be in a strike-slip faulting stress state. If Sᵥ=S₁, the crust is said to be in a normal faulting stress state which lies within the lower-left region 25.

While the constraints given by FIG. 1 are helpful and are used in oilfield development, for most practical purposes they are quite broad and not particularly useful for detailed decision-making on how to develop a reservoir. It would be useful to have additional and closer constraints in plots such as in FIG. 1 to serve as guidance during development. This problem is addressed in the present invention

### SUMMARY OF THE INVENTION

one embodiment of the measurement is a method of developing a reservoir in and heard formation. Seismic measurements are used for defining the first set of constraints in the stress diagram characterizing the subsurface, this stress diagram being related to principle stresses. Trend data are used for defining additional constraints in the stress diagram. An operation relating to development of the reservoir is performed using the first set of constraints and/or the additional constraints. Using seismic measurements may further involve making seismic measurements. Defining the first set of constraints may be based on using an overburden stress determined from the seismic measurements, a coefficient of friction determined from the seismic measurements, and a pore-pressure trend determined from the overburden stress and a velocity compaction trend. Determining the overburden stress may be based on using a density derived from the seismic measurements. The derivation of the density may be based on using a relationship between seismic velocity and density. The velocity compaction trend may be based on a relationship between velocity and effective stress in an interval where the pore-pressure is known to be hydrostatic. Defining the additional constraints may be based on estimating a porosity along a compaction trend, and using a relationship between a value of stress along a failure envelope where a deviatoric stress is zero and the estimated porosity. Defining the additional constraints may be based on using a Compaq shun trend to determine the relationship between velocity and a value of the stress along a failure envelope where the deviatoric stress is zero. The operation that is performed may be selecting a mime weight, and/o selecting an operating pressure when conducting hydraulic fracture stimulations.

another embodiment of the invention is a computer-readable medium used for implementing a method of developing a reservoir in the subsurface of an earth formation. The medium includes instructions which enables a processor to use seismic measurements for defining a first set of constraints in a stress diagram characterizing the earth formation, the stress diagram being related to principle stresses. The instructions further enables the processor to use trend data for defining additional constraints in the stress diagram, and determine a the mud weight used in drilling a well, and/or determine an injection pressure for a hydraulic fracturing operation.

### BRIEF DESCRIPTION OF THE FIGS.

The present invention is best understood with reference to the accompanying figures in which like numerals refer to like elements and in which:

FIG. 1 (prior art) illustrates the various stress regimes in the earth;

FIG. 2 is a plot of stresses in P-Q space;

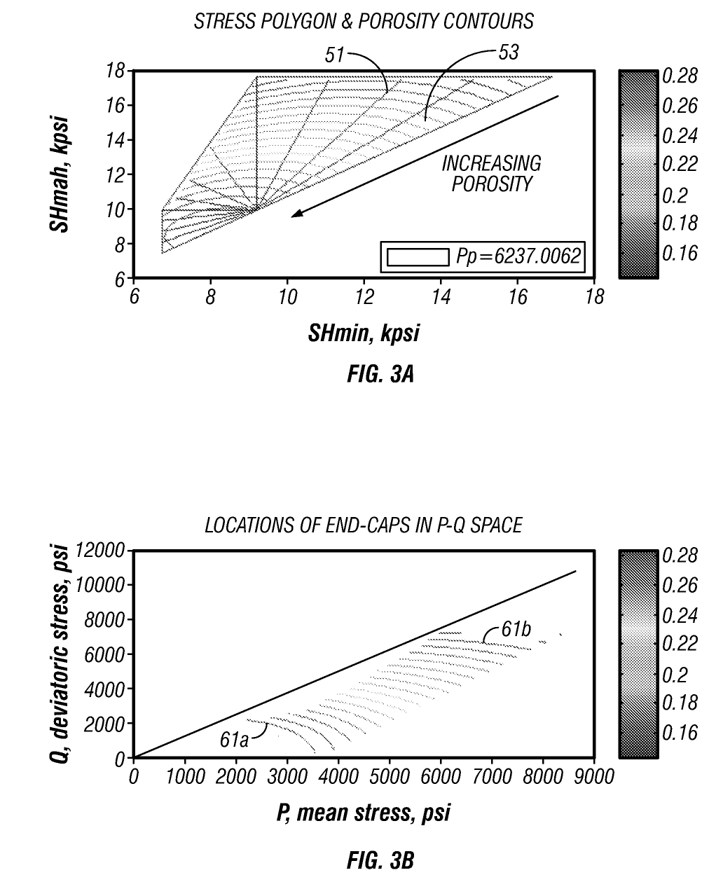

FIGS. 3a and 3b show plots of the Cam-Clay endcaps in Sₕₘᵢₙ-Sₕₘₐₓ space and P-Q space respectively;

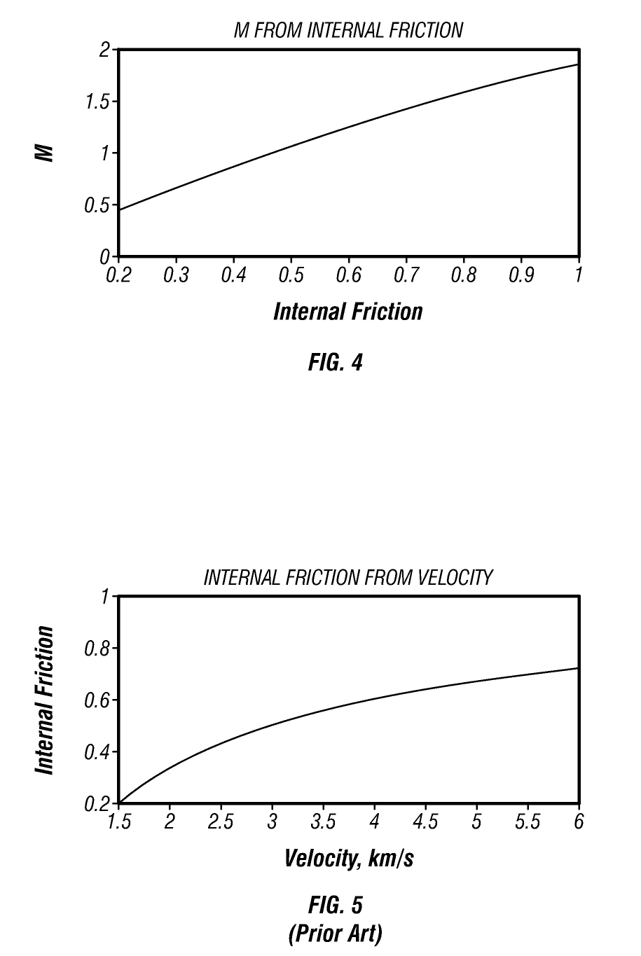

FIG. 4 shows the relationship between the shape parameter M and internal friction μ;

FIG. 5 (prior art) Relationship between velocity Vₚ and μ;

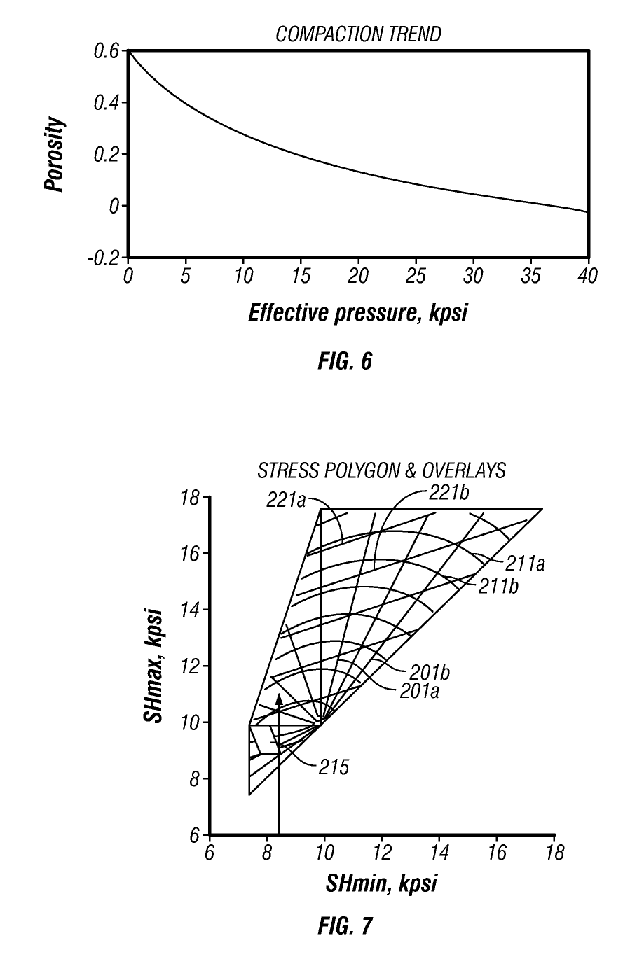

FIG. 6 is a plot of a typical compaction trend of porosity;

FIG. 7 is a plot showing additional constrains on the stress field determined from other data; and

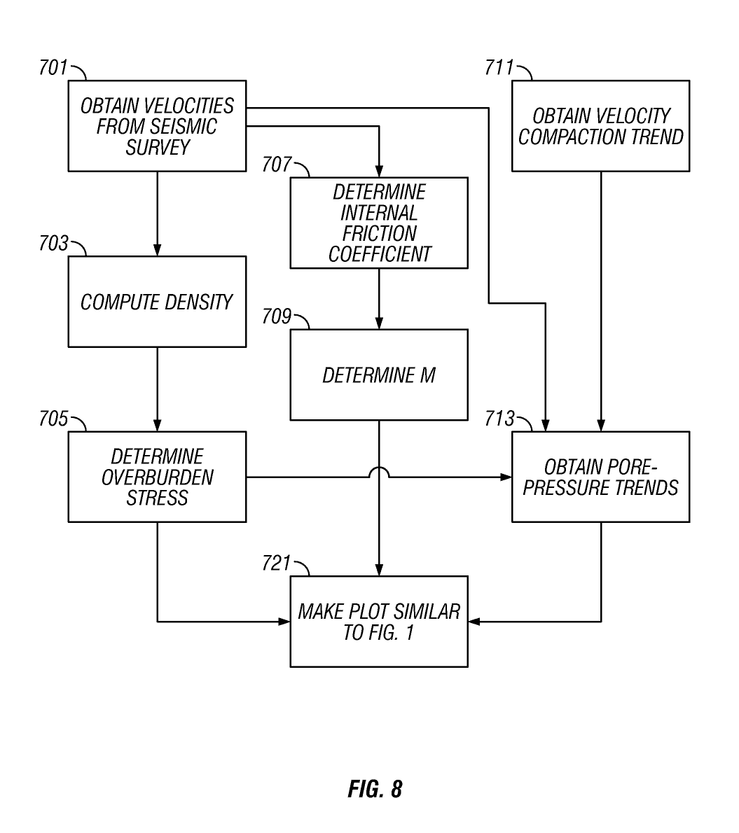

FIG. 8 is a flow chart illustrating some of the steps of the invention

### DETAILED DESCRIPTION OF THE INVENTION

The present invention describes a method whereby the strength of the intact rock limits the stress state. In this realization of the invention, the strength model is one that is appropriate for a compacting (young, unlithified) sediment.

It is known that when small stresses are applied to a rock, the rock initially deforms elastically (that is, upon release of the stress the rock returns to its unstressed state). Past a certain applied (typically, compressive) stress, however, the rock is said to deform plastically and some of the deformation is permanent. Teng-fong Wong and others, as detailed in Schutjens, et al. (2001) described the failure or yield of rocks in compression as having two possible modes. These are strain localization leading to creation of a shear fracture, and distributed, compactive deformation leading to a permanent reduction in volume. Since the volume of the rock is composed of two elements: the solid frame and the (typically, liquid or gas-filled) void space called the pore space, and since the pore space is considerably more compliant and is more likely to be permanently deformed than the materials that comprise the solid frame, compactive deformation typically leads to a reduction in porosity. Here, porosity is defined as the ratio of void space to total rock volume of solid plus void. This is given by the relation Φ=Vₚₒᵣₑ/(Vₚₒᵣₑ+V_{solid}). Raising the pore pressure causes an increase in the volume of the pore space and can partly offset the porosity and volume reduction due to the applied stress.

FIG. 2 shows a plot in P-Q space where, P is the mean stress and Q is the difference between the greatest and least compressive stress; Q can also be equal to the first deviatoric stress invariant, a measure of shear stress) of these two limits on the strength of a compactive rock. The abscissa is P and the ordinate is Q. The precise definition of Q is here given by the relation:
Q=\sqrt{(s₁−s₃)²+(s₂−s₁)²+(s₃−s₂)²}
Commonly, and as shown in FIG. 2, the approximation is made that Q is the difference between the greatest and least principle stress. The curve on the upper left 41 delineating that boundary of the region within which the rock is not at its failure limit is the shear or brittle faulting limit, which in some models has the same arithmetic relationship between the stresses as Eqn. 1. The curved limit on the right 47 sometimes referred to as the “end-cap”, which defines the limit on compressive stresses for rock with a given porosity. If stresses are within the stable region, the rock will deform in a largely elastic manner. If stresses reach values that would plot to the right of the end-cap, the porosity will be reduced until the rock reaches a stable state and can support the applied stresses. If the stress difference increases until it reaches the Mohr-Coulomb failure envelop, a shear failure plane will develop. The line 43 defines the boundary for shear-induced dilatation. The region below 45 is a near elastic regime where typically there are no visible changes to the microstructure and very small permeability changes.

One aspect of this invention is that it is possible to use knowledge of the relationship along the end-cap of porosity and stress to determine limits for the stress state and/or the pore pressure in the earth. While these limits are appropriate only in the absence of diagenesis and thermally-induced changes to mineral structure, it is possible using previously revealed methods (Bowers 1993; Moos and Zwart, 1998, using an independent measure of porosity) to determine whether the rock is in equilibrium with the end-cap (“normally compacted”) or overcompacted and/or affected by other processes. This allows determination of whether the limit is appropriate for a given rock.

There are a variety of models for the shape of an end-cap. This approach is not limited to using any particular model, and can also be applied in a time-dependent manner if the rock deformation is a function of time. One model that is commonly used (and will be used to illustrate the approach in this application) is the modified Cam Clay model, in which the end-cap forms an ellipse whose intersection with the x-axis (where Q=0) is called P*, and whose shape is defined by a parameter commonly called M. A. common form of the equation for the end-cap is
M²P²−M²P*P+Q²=0 (3).
There are a variety of criteria for the shape of the brittle failure line. One brittle failure criterion that is commonly used is the linear Mohr-Coulomb criterion, as defined similarly to Eqn. 1. This criterion is defined by two parameters, S₀ the intersection of the line with the P=0 or y-axis, and μ, which is related to the slope of the line. These limits can be defined taking into account only S₁ and S₃, or taking into account the intermediate stress S₂. In the current embodiment, the end-cap takes into account all three principal stresses. It is important to note that failure along the end-cap does not occur at a fixed orientation of the rock to the stresses. Failure due to strain localization, in contrast, results in a shear band or fault which has an orientation such that S₂ lies in the plane of the fault and the angle of the fault with respect to the S₁ direction is a function of μ. The parameter P* is a value of stress along a failure envelope where the deviatoric stress is zero.

It is possible to transform the trajectories in P-Q space that define the position of the endcap as a function of porosity into the Sₕₘᵢₙ-Sₕₘₐₓ stress space described in FIG. 1. FIG. 3b shows plots of modified Cam-Clay endcaps in P-Q space. FIG. 3a shows the position of the same lines in Sₕₘᵢₙ-Sₕₘₐₓ space. These lines in Sₕₘᵢₙ-Sₕₘₐₓ space define the limits of the stresses for a rock with the corresponding values of P* and M. Similarly to the frictional faulting limits, and in the absence of diagenesis or other non-compactive effects, if M and P* are as defined, the stresses must lie inside (below and to the right of) regions delimited by those lines that include the point labeled Sᵥ where all three stresses are equal. Along any contour in FIG. 3a, the stress and pore pressure are in equilibrium with the strength of a compacting material for the specific porosity. Radial lines such as 53 are lines of constant PHI from eqn (6). The direction of increasing porosity is shown by the arrows in FIG. 3a and 3b. For a rock having a known porosity, the stress state must lie within the polygon and below the contour line for a given porosity, such as 51 in FIG. 3a. Endcaps are indicated by contours such as 61a and 61b in FIG. 3b.

A further embodiment of this invention describes a way of determining P* and M for a given material. At the same time, this allows calculation of the value of μ the coefficient of friction that defines the locus of brittle failure. These methods are described next.

In the Cam Clay model, there is a relationship between M and μ defined by

$$M = \frac{6 μ}{3 \sqrt{{μ}^{2} + 1} + μ} . \qquad ( 4 )$$

This relationship is plotted in FIG. 4. The abscissa is the internal friction μ and the ordinate is M. Thus, if μ is known, M can be calculated.

Lal (1999) reveals a relationship between Vₚ, the compressional wave velocity, and μ for shales. This relationship is of the form:

$$μ = \frac{{V}_{p} - 1}{{V}_{p} + 1} . \qquad ( 5 )$$

This relationship is useful as the method of the present invention is particularly applicable to shales. Other relationships can also be used. This is important as velocity can be measured seismically and used to compute pore pressure using other methods. This relationship of eqn (5) is plotted in FIG. 5.

There remains only one uncertain parameter. That parameter is P*. One approach to determining P* is to utilize previous methods to determine a so-called “compaction trend” which defines the relationship between a measurable property and stress for a compacting material. This trend can be defined using measurements of velocity as a function of depth. An alternative approach is to define a relationship between mean stress or overburden stress and porosity, that in turn can be used to compute P* from Φ. A typical plot of a compaction trend (in this case Φ vs. mean stress) is plotted in FIG. 6. It is important in applying this method that consistent approaches must be used to define these various parameters. If consistent approaches are not used (for example, if P* is computed using a relationship between overburden and porosity) this technique must be applied iteratively. If the relationship is determined by measuring or computing porosity as a function of mean stress then P* is equal at each porosity to the mean stress.

Once all parameters have been defined as above, the curved end-caps on FIG. 3b can be relabeled to show limits on the stresses as a function of porosity. All that remains is to compute porosity, which requires a relationship between porosity and a measurable parameter. This parameter could be the velocity which is derived from seismic data. If the relationship between velocity and porosity is known, the limits can be plotted as a function of velocity. Alternatively, porosity can be determined using petrophysical log measurements in known ways. There are many known relationships between porosity and velocity, but caution must be employed to select the correct one for the rock under study.

This method can be applied using seismic data, or using petrophysical data acquired during drilling (in real-time or later) or by wireline logging. The limits can also be estimated using laboratory experiments on samples from which to determine P*ₘₐₓ, the maximum confinement ever applied to the material in situ. This parameter can be computed from the shape of a plot of porosity vs. pressure derived from laboratory data as a “knee” in the plot.

One illustration of the method is as follows. It assumes that the only information that is available is seismic interval velocity. Different approaches would be inferred by those skilled in the art. 1. A seismic survey is run over a region of a sedimentary structure. This may be done using known method in the art. 2. Interval or other true formation velocities are derived from the survey data as a function of depth and horizontal position. The determination of interval velocities from seismic survey data is well known in the art. 701 in FIG. 8 represents a combination of the first two steps here. 3. At 703, the density is computed using known relationships such as that of Gardner, Gardner & Gregory. 4. At 705 the overburden stress is determined by integrating the density. 5. At 707, the internal friction, μ, is computed from the velocity. This is given by the eqn. (5). 6. At 711, velocity compaction trends are obtained. These are relationships between velocity and effective stress in an interval where pore-pressure is known to be hydrostatic. This may be the shallow interval of the seismic section. 7. At 713 pore-pressure trends are obtained. Based on the obtained velocities and the velocity compaction trend-line, it is assumed that the same relationship holds in the entire section. This gives an estimate of the effective stress. That difference between the effective stress and overburden stress from 705 gives the pore-pressure. 8. Step 709 involves the determination of M from the internal friction coefficient. 9. At 721, the outputs from 705, 707 and 713 are used to make a plot similar to FIG. 1.

The steps identified above are a novel method of obtaining constraints such as those in FIG. 1. We next address the question of how to get additional constraints on the stress field. In one embodiment of the invention, porosity along the compaction trend as a function of pressure is computed from density or directly from a relationship between porosity and velocity. The density may be obtained, for example, from core measurements. The relationship between P* (which is a function of stress) and porosity is determined from the compaction trend. Plots of the end-cap as a function of porosity can be plotted on an Shₘᵢₙ-Shₘₐₓ plot on which may also be plotted the limits from frictional equilibrium. Using the porosity, the limits for the two horizontal stresses can be determined. See FIGS. 3a, 3b.

Alternatively, the compaction trend and the velocities are used to determine a relationship between Vₚ and P*. Plots of the end-cap as a function of velocity can be plotted on an Shₘᵢₙ-Shₘₐₓ plot on which may also be plotted the limits from frictional equilibrium. Using the velocity, the limits for the two horizontal stresses can then be determined.

Following the steps outlined above, in one embodiment of the invention, the results obtained are used to obtain a relationship between the horizontal and vertical stresses, and a compaction trend (step 6 above) is recomputed using that relationship. Using the new compaction trend the pore-pressure can be computed and the steps above repeated until the current pore-pressure and the stress limits are close to those computed in the previous steps. A further refinement of this method involves choosing a value of PHI, the ratio of principal stresses, defined as:

$$PHI = \frac{{S}_{1} - {S}_{2}}{{S}_{1} - {S}_{3}} . \qquad ( 6 )$$

If the compaction trend was derived using the mean stress, then the compaction trend itself provides a relationship between velocity and P*. If the overburden (vertical) stress was used to define the compaction trend, then the relationship between P* and velocity varies depending on the value of PHI, the relative magnitudes of the horizontal and vertical stresses, and also the value of the ratio S₁/S₃. The three equations to be solved are:

$$PHI = \frac{{S}_{1} - {S}_{2}}{{S}_{1} - {S}_{3}} , \\ 3 {P}^{*} = {S}_{1} + {S}_{2} + {S}_{3} , \\ {S}_{3} = \frac{{S}_{1}}{a}$$

These equations can be solved iteratively, by first assuming that all three stresses are equal to Sᵥand using the method in step 7 to define contours as in FIG. 3a. Then, for each Φ value (constant along lines such as those shown in FIG. 7 that radiate outward from S₁=S₂=S₃) the intersection of a particular porosity contour defines the value of a for which the stresses are in equilibrium with the porosity along the compaction trend. The values of a and Φ are then used to compute a new relationship between P* and Vₚ, and the process is repeated. Lines of constant P* (equivalently, of porosity or Vₚ) on figures such as FIG. 3a or FIG. 7 will be slightly shifted. After a sufficient number of iterations, the final result will converge producing a stable set of lines of constant P* (equivalently, of porosity or Vₚ) as in FIGS. 3a and 7.

As noted above, lines of constant PHI are overlain on the plot in FIG. 3a, and are also shown in FIG. 7. If PHI can be constrained, for example, from the known tectonic state based on fault activity or structure or geologic setting, the range of possible stresses can be further constrained to lie within or along those limiting lines of PHI.

If this method is applied to data from a previously drilled well, additional constraints can be applied, as revealed in the GMI•SFIB module CSTR. These include the stresses that would cause breakouts or tensile failures with specific characteristics and at specific positions around a previously drilled well.

FIG. 7 shows all of these limits overlain on a single stress plot. The edges of the polygon are contraints based on the frictional strength of faults. The lines radiating outward from Sₕₘᵢₙ=SHₕₘₐₓ=Sᵥare lines of constant PHI. The lines 211a, 211b are limits based on a Cam-Clay model for the strength of a compacting material. The region 215 illustrates diagrammatically, the limits on stress magnitudes from analysis of wellbore breakouts in a deviated well, where breakout position is a function of the stress magnitudes as well as their orientations. Finally, the lines such as 221a, 221b trending upward to the right show stress states that would initiate breakouts in a vertical well for which the mud weight is equal to the pore pressure, for various values of rock strength Co and the given coefficient on friction μ. Here, the sliding friction on faults and the internal friction that defines the slope of the Mohr-Coulomb failure limit are the same; there is no reason that they have to be however. Also shown is a heavy vertical arrow indicating a case in which S₃ is known. If so, the stresses must lie along this arrow. Tensile failure limits are not shown but could be. These limits are lines, different for different values of tensile strength, extending approximately parallel to the upper left-hand edge of the polygon.

for the purposes of the present invention figures such as FIG. 1, FIGS. 3a, 3b and FIG. 7 are referred to as stress diagrams related to principal stresses in the subsurface. The method of the present invention can thus be considered as first defining constraints in a stress diagram describing the subsurface and then making of operational decisions on the development based on the constraints.

It is important to quantify pore pressure because high pore pressure leads to unsafe drilling conditions, for example blowouts and increased risk of wellbore collapse. In addition, reservoirs with elevated pore pressure cannot support large hydrocarbon columns (reducing the amount of producible fluids and therefore the value of assets), such that knowing pore pressure is required to know how much hydrocarbon is available to be produced and to predict the positions of the fluid contacts between liquid and gaseous hydrocarbons and water.

Stresses are related to pore pressure such that in this approach you cannot compute one without knowing something about the other (in fact, disequilibrium compaction analysis is a simplified form of the approach employed here, that either assumes a 1-D state of stress or heuristically applies corrections for “lateral stresses”). See U.S. patent application Ser. No. 10/819,665 of Moos having the same assignee as the present application and the contents of which are incorporated herein by reference.

It is important to quantify stress magnitudes because stresses control a number of important characteristics of reservoirs. Often, reservoir fluids are trapped against overlying faults, which if they slip will cause fluids to escape (breached seals). Knowing stress magnitudes allows prediction of the pressure at which this occurs, and given knowledge of pore pressure and fluid density this makes it possible to compute the height of an oil or gas column that can be trapped against such a fault.

Fault slip occurs along faults when the shear stress exceeds their strength. Knowing the magnitudes of all three of the stresses allows prediction of when this will occur for faults of all orientations. Knowing the current stress magnitudes also allows extrapolating how those stresses change due to changes in fluid pressure, for example, due to fluid extraction or injection.

When wells are drilled into the earth the in situ stresses are concentrated around the well in a known way. If the stress concentration exceeds the strength of the rock, the well collapses. This risk is mitigated by using a heavy mud to generate an internal pressure to support the wall of the hole. But, if the mud pressure exceeds the least stress in the earth, the well can fracture leading to sudden decreases in pressure, massive losses of expensive mud, and collapse of the well. Because these limits are functions of all three stresses and of the orientation of the well, knowing the magnitudes of all three of the stresses is essential to quantify the safe upper and lower bound mud weights.

Reservoirs deform in response to changes in fluid pressure and stress. Predicting this behavior depends on knowing both the stress magnitudes and the stress magnitude limits imposed by the intrinsic strength of the reservoir rock. For example, if the stresses are in equilibrium with the rock strength then any further increase in stress may lead to large amounts of mostly irreversible compaction, leading to subsidence, collapse of well casings, shearing and fault activation which can damage or destroy surface and subsurface facilities/pipelines. For example, the City of Long Beach requires oil and gas companies to guarantee that their operations do not cause ground subsidence beyond the more than 30 feet that has already occurred since the late 1940's due to production from the Wilmington field. If present-day stresses are smaller than can be supported by the rock, then stress and pressure changes can occur with much smaller and largely reversible volume changes. The methods described here allow identification of the limits on stresses imposed by the strength of the rock, providing a means to differentiate between the above two scenarios.

It is generally accepted that stresses in the earth vary from one depth to the next, due to differences in the properties of the layered earth materials. Knowing how stresses are constrained allows prediction of the behavior of hydraulically induced fractures created to enhance exploitation of oil and gas resources, and also to ensure isolation of materials injected into the earth for long-term storage. Primarily, it allows determination of the safe operating pressures to achieve the desired treatment results.

Because stresses change over the life of a field, knowing the starting stress state is important to predict those changes. In turn the changing stresses result in changes in the forces applied by the earth to the manufactured materials used to complete wells. For example, if stresses are known to be close to the limits imposed by rock strength, production-induced changes can cause significant amounts of disaggregated sand to be produced near the well, which can be drawn into the well along with produced fluids leading to damage due to erosion as well as increased costs to dispose of the produced materials. On the other hand, injection at too high pressure can lead to creation of hydraulic fractures (the pressure for this to occur is the least principal stress) or can cause the rock to fail near the well due to the decrease in effective stress, again leading to the potential for large amounts of solids production if pressure in the well drops and fluid flow reverses into the well.

Implicit in the processing method of the present invention is the use of a computer program implemented on a suitable machine readable medium that enables the processor to perform the control and processing. The machine readable medium may include ROMs, EPROMs, EAROMs, Flash Memories and Optical disks. Such a computer program may output the results of the processing, such as the stress constraints, to a suitable tangible medium. This may include a display device and/or a memory device.

While the foregoing disclosure is directed to the specific embodiments of the invention, various modifications will be apparent to those skilled in the art. It is intended that all such variations within the scope and spirit of the appended claims be embraced by the foregoing disclosure.

What is claimed is:

1. A method of developing a reservoir in an earth formation, the method comprising:
(a) using seismic measurements for defining a first set of constraints in a stress diagram characterizing the earth formation, the stress diagram being related to principal stresses;
(b) using trend data for defining additional constraints in the stress diagram;
(c) performing an operation relating to the development of the reservoir based on at least one of the first set of constraints and the additional constraints.

2. The method of claim 1 wherein using seismic measurements further comprises making seismic measurements.

3. The method of claim 1 wherein defining the first set of constraints comprises using (i) an overburden stress determined from the seismic measurements; (ii) a coefficient of friction determined from the seismic measurements, and (iii) a pore pressure trend determined from the overburden stresses and a velocity compaction trend.

4. The method of claim 3 wherein determining the overburden stress further comprises using a density derived from the seismic measurements.

5. The method of claim 4 wherein deriving the density further comprises using a relationship between seismic velocity and density.

6. The method of claim 3 wherein the velocity compaction trend further comprises a relationship between velocity and effective stress in an interval where the pore-pressure is known to be hydrostatic.

7. The method of claim 1 wherein defining the additional constraints further comprises:
(i) estimating a porosity along a compaction trend, and
(ii) using a relation between a value of a stress along a failure envelope where a deviatoric stress is zero and the estimated porosity.

8. The method of claim 1 wherein defining the additional constraints further comprises:
(i) using a compaction trend to determine the relationship between velocity and a value of a stress along a failure envelope where the deviatoric stress is zero.

9. The method of claim 1 wherein the operation is selected from the group consisting of (i) selecting a mud weight, (ii) selecting an operating pressure when conducting hydraulic fracture stimulations.

10. A computer-readable medium used for implementing a method of developing a reservoir in an earth formation, the medium including instructions which enable a processor to:
(a) use seismic measurements for defining a first set of constraints in a stress diagram characterizing the earth formation, the stress diagram being related to principal stresses;
(b) use trend data for defining additional constraints in the stress diagram; and
(c) determine at least one of (i) a mud weight used in drilling of a well in the earth formation, and (ii) determine an injection pressure for a hydraulic fracturing operation.

11. The medium of claim 10 further comprising at least one of (i) a ROM, (ii) an EPROM, (iii) an EAROM, (iv) a flash memory, and (v) an optical disk.
